(19) United States
(12) Patent Application Publication
(10) Pub. No.: US 2025/0379796 A1
(43) Pub. Date: Dec. 11, 2025

(54) COMMUNICATION DEVICES AND METHODS FOR MACHINE LEARNING MODEL TRAINING

(71) Applicant: SHENZHEN TCL NEW TECHNOLOGY CO., LTD., Shenzhen, Guangdong (CN)

(72) Inventor: Junrong GU, Shenzhen, Guangdong (CN)

(73) Assignee: SHENZHEN TCL NEW TECHNOLOGY CO., LTD., Shenzhen, Guangdong (CN)

(21) Appl. No.: 18/875,069

(22) PCT Filed: Sep. 30, 2022
(86) PCT No.: PCT/CN2022/123286

§ 371 Date: Dec. 13, 2024

(51) Int. Cl. H04L 41/16; H04B 7/06; H04W 72/232

(52) U.S. Cl. CPC H04L 41/16; H04B 7/0626; H04W 72/232

(57) ABSTRACT

A method for configuring at least one first node training machine learning (ML) model includes being provided with a training assistant information by a second node, wherein the training assistant information is used for the first node to perform joint training with the second node to train a plurality of ML models having a common part.

### BACKGROUND OF DISCLOSURE

### 1. Field of the Disclosure

The present disclosure relates to the field of wireless communication systems, and more particularly, to communication devices and methods for machine learning (ML) model training, for example, the present disclosure is related to the new study item description (SID) on AI/ML for new radio (NR) air interface of the Release 18, which is established in 3rd generation partnership project (3GPP) radio access network (RAN) plenary meetings 94e in December 2022. The discussion is led by RAN1 and begins in May 2022. Particularly, the present disclosure is related to an enhanced channel state information (CSI) report feedback, beam management and/or positioning, wherein several ML models can have a common part. For enhanced CSI feedback, the ML models can have a common CSI generation part or a common CSI reconstruction part.4

### 2. Description of the Related Art

The AI/ML is applied to the 3GPP RAN1. Several use cases are decided to be studied. They are respectively a CSI feedback enhancement, a beam management, and a positioning. As indicated in the 3GPP new SID, although specific AI/ML algorithms and models may be studied for evaluation purposes, AI/ML algorithms and models are implementation specific and are not expected to be specified. The ML models will experience several stages. The ML model can be trained as first, either online or offline. Then the ML model is deployed. After deployment, the ML model is activated and the inference stage begins. At inference stage, the ML models (with or without a common part) will be monitored. There are some issues on how to determine whether there is a malfunction on the ML model for a UE and/or how to deactivate the common part of ML models if model malfunction occurs. As a result, the activation and deactivation of the plurality of ML models with a common part need to be discussed.

If this the AI/ML based CSI compression sub use cases support the ML models with a common part, a design to save the signalings is needed. If the related UEs is configured one by one for the multiple ML models in a straightforward sense, it would be a very tedious task. Furthermore, the joint training of the plurality of ML models with a common part need to be discussed. How to update the common model part, or merely one non-common model part is updated? Some rules are needed to be designed for this, in order to simultaneously training multiple ML models with a common part. The ML model for CSI feedback is a two-sided model. Currently, there is no solution about the joint training of ML models with a common part for CSI feedback.

Therefore, there is a need to design new model training methods for communication devices and methods for machine learning (ML) enhancement in PHY and MAC, which can solve the issues in the prior art, ease the management of a plurality of ML models with a common part, provide methods of training of a plurality of ML models with a common part, reduce system overhead, provide a good communication performance, and/or provide high reliability.

### SUMMARY

An object of the present disclosure is to propose communication devices and methods for machine learning (ML) model training, which can solve the issues in the prior art, case management of a plurality of ML models with a common part, provide methods of training of a plurality of ML models with a common part, reduce system signaling overhead, provide a good communication performance, and/or provide high reliability.

In a first aspect of the present disclosure, a method for configuring at least one first node training machine learning (ML) model includes being provided with a training assistant information by a second node, wherein the training assistant information is used for the first node to perform joint training with the second node to train a plurality of ML models having a common part.

In a second aspect of the present disclosure, a first node comprises a memory, a transceiver, and a processor coupled to the memory and the transceiver. The processor is configured to execute the above method.

In a third aspect of the present disclosure, a communication system comprises a memory, a transceiver, and a processor coupled to the memory and the transceiver. The processor is configured to execute the above method.

In a fourth aspect of the present disclosure, a second node comprises a memory, a transceiver, and a processor coupled to the memory and the transceiver. The processor is configured to execute the above method.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

In a tenth aspect of the present disclosure, a communication system for configuring at least one first node training machine learning (ML) model includes a first node and a second node, wherein the first node is provided with a training assistant information by the second node, wherein the training assistant information is used for the first node to perform joint training with the second node to train a plurality of ML models having a common part.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a basic auto-encoder model for enhanced CSI feedback according to an embodiment of the present disclosure.

FIG. 2 is a block diagram of one or more user equipments (UEs) and a base station (e.g., gNB) of communication in a communication network system according to an embodiment of the present disclosure.

FIG. 3 is a flowchart illustrating a method for configuring at least one first node training machine learning (ML) model according to an embodiment of the present disclosure.

FIG. 4 is a schematic diagram illustrating an example of a basic auto-encoder model for enhanced CSI feedback according to an embodiment of the present disclosure.

FIG. 5 is a schematic diagram illustrating an example of a functional framework of RAN intelligence according to an embodiment of the present disclosure.

FIG. 6 is a schematic diagram illustrating an example of two UEs with corresponding encoder share a common decoder at the gNB side according to an embodiment of the present disclosure.

FIG. 7 is a schematic diagram illustrating an example of forward propagation and backward propagation to train ML models having common part according to an embodiment of the present disclosure.

FIG. 8 is a schematic diagram illustrating an example of forward propagation and backward propagation to train ML models having a common part according to an embodiment of the present disclosure.

FIG. 9 is a schematic diagram illustrating an example of forward propagation and backward propagation to train ML models having a common part according to an embodiment of the present disclosure.

FIG. 10 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The AI/ML is introduced into a physical (PHY) layer and a medium access control (MAC) layer, to enhance the system performance. Several use cases are decided to be studied in 3GPP RAN1. They are respectively the CSI feedback compression, the beam management, and the positioning. The ML learning models can be trained either online or offline.

For machine learning models deployed in at least one cell, they can have a common part. This is a kind of ML model generalization. The common part can handle the data to or from a few non-common parts. The management of such ML models need unified signalings. Otherwise, if these ML model is configured one by one, that would be time consuming and resource wasting. To solve this problem, the ML models with a common part can be managed by a broadcast-like signaling.

Some embodiments of the present disclosure discuss the CSI feedback enhancement case. FIG. 1 is a schematic diagram illustrating an example of a basic auto-encoder model for enhanced CSI feedback according to an embodiment of the present disclosure. FIG. 1 illustrates that, in some embodiments, a basic model of auto-encoder is shown as follows. The encoder compressed the raw CSI-RS values (in short, raw CSI)/maximum Eigen vector and reports its output to the gNB. The gNB will decompress it. A new CSI report is the CSI report that contains the enhanced CSI feedback by an AI/ML model.

Further, the AI/ML is introduced into PHY layer and MAC layer, to enhance the system performance. Several use cases are decided to be studied in 3GPP RAN1. They are respectively the CSI feedback compression, the beam management, and the positioning. The ML learning models should be trained either online or offline.

At the UE side, the input is compressed and output to the channel for ML enhanced CSI feedback. The input can be either (maximum) Eigen vectors or channel matrix. The compressed output is input to the decoder and reconstructed at the gNB side. Several type of ML models of training ML methods are discussed, including training at UE side, and delivering the ML model to gNB; training at gNB side, and delivering the model to the UE; joint training by both UE and gNB, separate training at UE and gNB. Some embodiments of the present disclosure mainly discuss joint training by both UE and gNB.

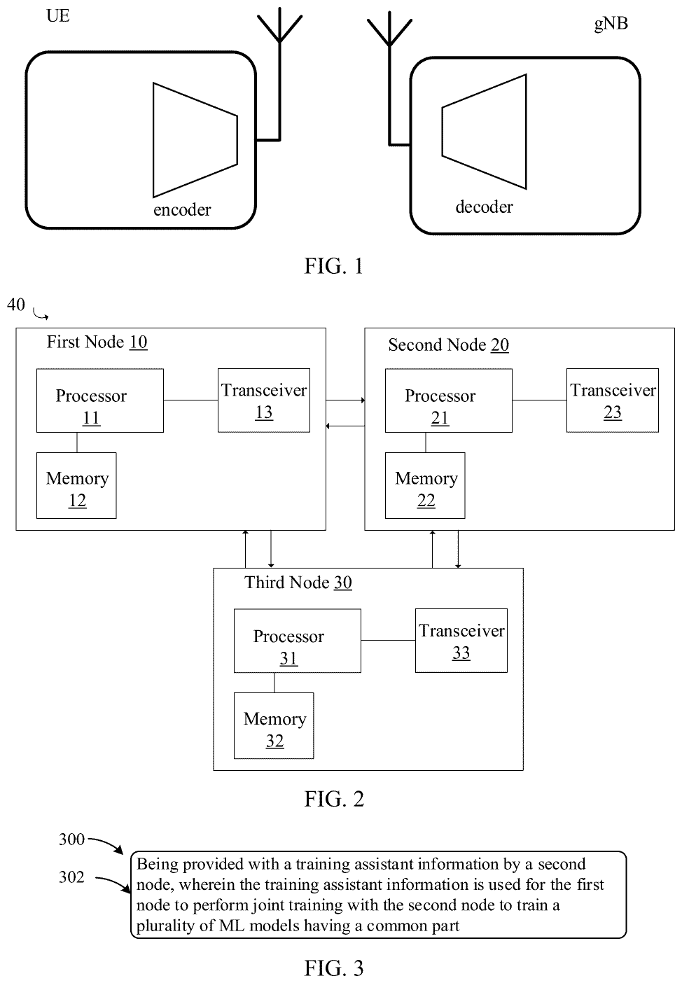

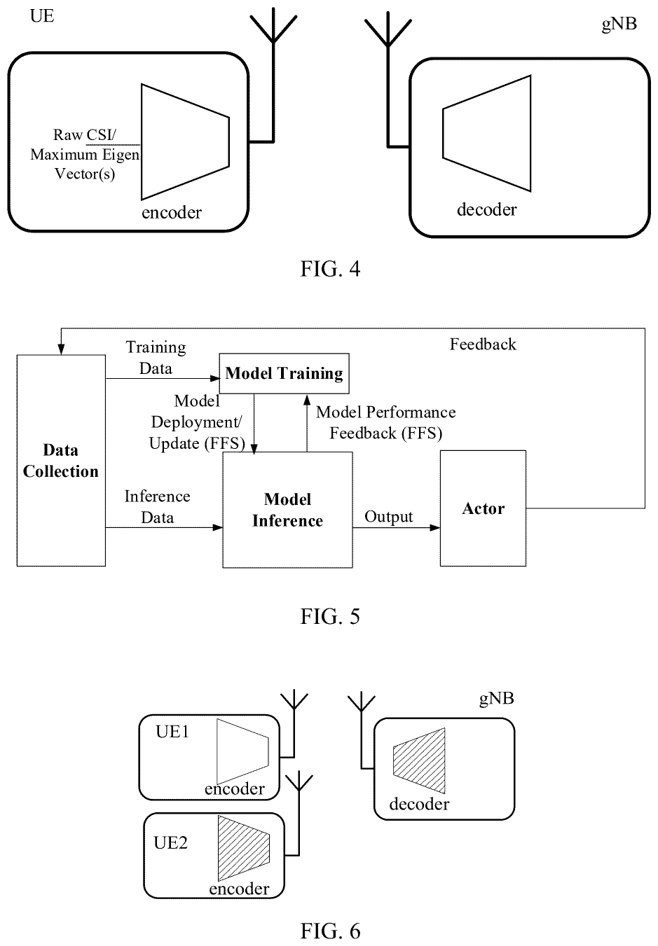

FIG. 2 illustrates that, in some embodiments, at least one first node 10 such as at least one user equipment (UE), and a second node 20 such as base station (e.g., gNB) 20, and at least one first node 30 such as at least one user equipment (UE) for communication in a communication network system 40 according to an embodiment of the present disclosure are provided. The communication network system 40 includes at least one first node 10 such as at least one user equipment (UE), and a second node 20 such as base station (e.g., gNB) 20, and at least one first node 30 such as at least one user equipment (UE). The at least one first node 10 may include a memory 12, a transceiver 13, and a processor 11 coupled to the memory 12 and the transceiver 13. The at least second first node 20 may include a memory 22, a transceiver 23, and a processor 21 coupled to the memory 22 and the transceiver 23. The at least one third node 30 may include a memory 32, a transceiver 33, and a processor 31 coupled to the memory 32 and the transceiver 33. The processor 11, 21, or 31 may be configured to implement proposed functions, procedures and/or methods described in this description. Layers of radio interface protocol may be implemented in the processor 11, 21, or 31. The memory 12, 22, or 32 is operatively coupled with the processor 11, 21, or 31 and stores a variety of information to operate the processor 11, 21, or 31. The transceiver 13, 23, or 33 is operatively coupled with the processor 11, 21, or 31, and the transceiver 13, 23, or 33 transmits and/or receives a radio signal.

The processor 11, 21, or 31 may include application-specific integrated circuit (ASIC), other chipset, logic circuit and/or data processing device. The memory 12, 22, or 32 may include read-only memory (ROM), random access memory (RAM), flash memory, memory card, storage medium and/or other storage device. The transceiver 13, 23, or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22, or 32 and executed by the processor 11, 21, or 31. The memory 12, 22, or 32 can be implemented within the processor 11, 21, or 31 or external to the processor 11, 21, or 31 in which case those can be communicatively coupled to the processor 11, 21, or 31 via various means as is known in the art.

FIG. 3 illustrates a method 300 for configuring at least one first node training machine learning (ML) model according to an embodiment of the present disclosure. In some embodiments, the method 300 includes: a block 302, being provided with a training assistant information by a second node, wherein the training assistant information is used for the first node to perform joint training with the second node to train a plurality of ML models having a common part. This can solve the issues in the prior art, case management of a plurality of ML models with a common part, provide methods of training of a plurality of ML models with a common part, reduce system signaling overhead, provide a good communication performance, and/or provide high reliability.

In some embodiments, the processor 11 and/or the processor 21 is used to perform the method 300 for configuring at least one first node training machine learning (ML) model. This can solve the issues in the prior art, case management of a plurality of ML models with a common part, provide methods of training of a plurality of ML models with a common part, reduce system signaling overhead, provide a good communication performance, and/or provide high reliability.

In some embodiments, the first node is a user equipment (UE), the second node is a base station, at least one third node is at least one another UE, an encoder of the UE and an encoder (CSI generation part) of the at least one another UE share a common decoder at the base station, the encoder of the UE and the encoder of the at least one another UE refer to one of a channel state information (CSI) generation part and a CSI reconstruction part, and the common decoder of the base station refers to the other of the CSI generation part and the CSI reconstruction part. In some embodiments, the training assistant information is contained in a UE-group common signaling or a broadcast-like signaling, which is contained in a downlink control information (DCI) 2_0 or a DCI 2_x, or the training assistant information is contained in a system information block (SIB) and/or a master information block (MIB).

In some embodiments, the training assistant information comprises at least one of the followings: an activation/enabling of ML model training, a period of report forward propagation data, a period of report backward propagation data, a deactivation/disabling of ML model training, and an identification information. In some embodiments, the activation/enabling of ML model training, the quantization levels of forward propagation, the quantization levels of backward propagation, and the deactivation/disabling of ML model training are DCI fields in the DCI 2_0 or a DCI 2_x. In some embodiments, the period of report forward propagation data and/or the period of report backward propagation data is configured by the second node and has bits, a list, or a table, or the period of report forward propagation data and/or the period of report backward propagation data is a default period.

In some embodiments, the identification information comprises at least one of the followings: a cell identifier (ID) of a second node or a radio network temporary identifier (RNTI), where the UE-group common signaling is scrambled by a slot format indication radio network temporary identifier (SFI-RNTI) for the DCI_2.0 or a new RNTI for the DCI 2_x. In some embodiments, the at least one first node and the second node deployed with the ML models having a common part, where the at least one first node makes a group. In some embodiments, a grouping rule of making the group comprises at least one of the followings: a beam, wherein the at least one first node connected to the same beam of the second node are grouped together and paired with a common ML model part; a cell residual time of the first node, wherein the at least one first node connected to the second node longer than a time are grouped together, and paired with a common ML model part; a distance, wherein the at least one first node connected to the second node falling into the same distance range regarding the second node are grouped together and paired with a common ML model part; and a channel condition, wherein the at least first node has the same channel condition are grouped together and paired with a common ML model part, wherein the same channel condition comprises the signal to noises (SNRs) the time delay, and/or the doppler within a same range.

In some embodiments, during training, a forward propagation and a backward propagation make a loop for encoders of the at least one first node the common decoder of the second node. In some embodiments, each of the at least one first node contributes to the forward propagation, after a loss function is calculated by the second node, the back propagation begins and send updated parameters to each of the first node and the at least one third node. In some embodiments, the at least one first node reports a forward propagation data and a ground truth in a batch, from a single measurement, from a single input of the encoder, from a plurality of measurements, or from a plurality of inputs of the encoder.

In some embodiments, during training, the at least first node reports a forward propagation in a batch, and a back propagation is performed to all the at least one first node, even though some of the at least first node does not report the forward propagation since a last propagation. In some embodiments, one or more reports of the forward propagation from one of the at least one first node triggers one back propagation of all involved ones of the at least one first node. In some embodiments, for the ML models with a common CSI reconstruction part, involved one of the at least one first node does not expect receiving any data or any back propagation data for gradient descend during joint model training if a forward propagation data is not sent in one training loop.

In some embodiment, the quantization of forward propagation data is a scalar quantization or a vector quantization. The quantization levels of scalar quantization or vector quantization is indicated in the training assistant information. In some examples, the quantization of backward propagation data is a scalar quantization or a vector quantization. The quantization levels of scaler quantization or vector quantization is indicated in the training assistant information. Generally, the quantization of forward propagation data and the quantization of backward propagation data should be kept with less bits, otherwise, the overhead of training would be very big. Thus, in order to reduce the training overhead, the quantization of forward propagation data should be coarse quantization or with low quantization levels, for example 8-bit scalar quantization of a real number. Whereas, for backward quantization, quantization should be with high precision. Otherwise, the ML model would not converge smoothly, or fast. In some examples, the quantization in training assistant information contains one bit denotes quantization type, i.e., the quantization is {0/1} scalar quantization or {1/0} vector quantization for forward propagation and backward propagation, respectively. If the quantization type is not configured, the default is vector quantization or scalar quantization.

In some examples, the quantization is uniformly configured by training assistant information by a broadcast-like singaling. Furthermore, quantization can be reconfigured by a DCI/MAC-CE/RRC signaling to have a different value of quantization level/quantization method. The quantization level or quantization method can be or not be fixed during training of ML models (with a common part).

In some embodiments, the at least one first node reports a forward propagation data in a batch, and a backward propagation is performed to the reporting ones of the first node and the at least one third node. In some embodiments, the one of the at least one first node does not report any forward propagation data since a last propagation, does not perform the back propagation. In some embodiments, a training of a ML model part which is at the at least one first node, is performed individually and independent from the other of the at least one first node and the at least one first node performs training in turn. In some embodiments, a training type of ML models with a common part is configured by the second node. In some embodiments, the training type of ML models with the common part is configured to the at least one first node by the second node through a radio resource configuration (RRC) signaling, a media access control-control element (MAC-CE), or a DCI field.

FIG. 5 is a schematic diagram illustrating an example of a functional framework of RAN intelligence according to an embodiment of the present disclosure. FIG. 5 illustrates that, in some embodiments, the ML models need to be monitored during model inference. A functional framework of RAN intelligence is provided in RAN3. It can be further modified for RAN1. The ML Model will be monitored after deployment to check whether it works properly. Usually, the ML model performance is compared to a criterion. If the ML model does not work properly. The UE will switch to another ML model, or fallback to the non-AI working way. The ML model being monitored will be retrained.

### Embodiment 1

FIG. 6 is a schematic diagram illustrating an example of two UEs with corresponding encoder share a common decoder at the gNB side according to an embodiment of the present disclosure. FIG. 6 illustrates that, as an example, there are several first nodes, which can be UEs, and the one second node, which can be gNB. The encoder of UE 1 and encoder of UE2 shares a common decoder at the gNB. The decoder refers to the CSI reconstruction part and the encoder refers to the CSI generation part. When the gNB configures the encoders of a plurality of UEs (UE1 and UE2 here), the configuration information should be a broadcast-like signal, transmitted downlink. The configuration information is training assistant information.

As an example, the training assistant information is contained in DCI 2_0 or new DCI 2_x. As an example, the training assistant information comprises at least one of followings, activation/enabling of ML model training, the period of reporting forward propagation data, the period of sending backward propagation data, deactivation/disabling of ML model training, quantization information and the identification information of the second node (BS).

The activation/enabling of ML model training is a DCI field in DCI 2_0 or a new DCI 2_x. The deactivation/disabling of ML model training is a DCI field in DCI 2_0 or a new DCI 2_x. In some examples, it is a one-bit field in DCI 2_x, where “1” indicates the activation of training of the related plurality of ML models. “0” indicates the deactivation of training of the related plurality of ML models. The period of report forward propagation data, is configured by gNB which is list or a table. The forward propagation is a step of training the ML model. For ML model of CSI feedback, the data is fed into the input and calculated and passing through each layer. That is forward propagation.

A bitmap in DCI format 2_0 has a one-to-one mapping with a set of period of reporting forward propagation data, where a value of ‘0’ indicates that a report period is available for receptions and a value of ‘1’ indicates that a report period not available for receptions, by availablePeriod-FP-PerCell, and the bitmap in DCI format 2_x/2_0. The availablePeriod-FP-PerCell remains available or unavailable until the end of the training durations/mode unless reconfigured.

The back propagation is a step in ML model training. The gradient is calculated from the loss function and back propagated from the output layer to the input layer. A bitmap in DCI format 2_0 has a one-to-one mapping with a set of period of providing backward propagation data to UE, where a value of ‘0’ indicates that a report period is available for receptions and a value of ‘1’ indicates that a report period is available is not available for receptions, by availablePeriod-BP-PerCell, and the bitmap in DCI format 2_x/2_0. The availablePeriod-BP-PerCell set remains available or unavailable until the end of the training durations/mode unless reconfigured. In another example, the period of report forward propagation data or back propagation, is configured by gNB which is several bits. For example, a two bits case.

Two bits case:

| 00 | 01 | 10 | 11 |
|---|---|---|---|
| 5 ms | 10 ms | 20 ms | 40 ms |

1 In another example, if availablePeriod-FP-PerCell is not configured. There is a default reporting period, default period is one from {5 ms, 10 ms, 20 ms, 30 ms, 40 ms, 60 ms, 100 ms}. In another example, if availablePeriod-BP-PerCell is not configured. There is a default reporting period, {5 ms, 10 ms, 20 ms, 30 ms, 40 ms, 60 ms, 100 ms}. In another example, the default reporting forward propagation data of the ML model for CSI feedback with a common part is periodic or semi-persistent. A field in DCI 2_x can be provided to UE. If The UEs receives the DCI 2_x and decode the field as activation, reporting forward propagation data will be activated, when the reporting is in semi-periodic model. Otherwise, the reporting forward propagation data will be deactivated.

In another example, the default reporting backward propagation data of the ML model for CSI feedback with a common part is periodic or semi-periodic. A field in DCI 2_x can be provided to UE. If The UEs receives the DCI 2_x and decode the field as activation, receiving the backward propagation data will be activated, when the reporting is in semi-periodic model. Otherwise, the receiving backward propagation data will be deactivated.

In another example, the default reporting forward propagation data of the ML model for CSI feedback with a common part is aperiodic. The reporting of reporting forward propagation data is triggered by a DCI. In another example, the default reporting backward propagation data of the ML model for CSI feedback with a common part is aperiodic. In some examples, it is relying on the UE request. if the UE has not received the backpropagation data, after a time window/threshold, the UE would request the backpropagation data from gNB. The time window/threshold is configured by gNB as an RRC signaling. If it is not configured, there is a default value.

The training assistant information is identified by the identification information of the second node comprises at least one of the following, cell ID, or RNTI. For example, the UE-group common signaling is scrambled by SFI-RNTI for DCI_2.0 or a new RNTI, for DCI 2_x. SFI-RNTI: Slot Format Indication Radio Network Temporary Identifier. RNTI: Radio Network Temporary Identifier.

In some examples, the UEs deployed with ML models having a common part makes a group and are provided UE-group common signalings. In some examples, the grouping rule comprise at least one of follows.

The beam: The UEs connected to the same beam of the gNB is grouped together.

The cell residual time of the UE: The UEs which connect to the gNB longer than a time are grouped together.

The distance: The UEs to connected gNB fall into same distance range are grouped together.

The UEs have similar channel conditions are grouped together, for example similar SNR (the SNRs within a range).

After UE grouping, the UEs are deployed with ML models having a common part.

### Embodiment 2

In another example, the training assistant information, is in SIB/MIB. As an example, the training assistant information comprises at least one of followings: activation/enabling of ML model training, deactivation/disabling of ML model training, and the identification information of the second node.

As an example, there can be a field in SIB(x)/MIB. ML-model-training-common {0/1}, where {0} indicates the activation/enabling of ML model training. As an example, it is for CSI feedback. {1} indicates the deactivation/disabling of ML model training. As an example, it is for CSI feedback. Such that all the UEs within the current cell will be provided with this information, and this information ca be configured for training ML model.

### Embodiment 3

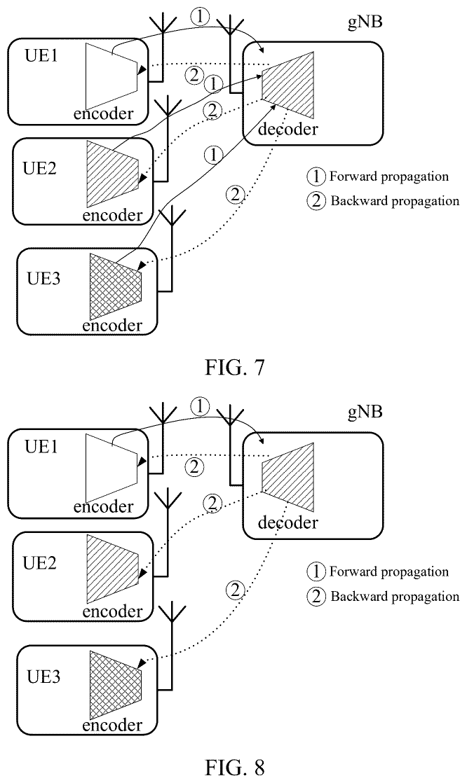

FIG. 7 is a schematic diagram illustrating an example of forward propagation and backward propagation to train ML models having common part according to an embodiment of the present disclosure. FIG. 7 illustrates that, in order for an ML model to converge smoothly and fast, during training, the data is fed into the ML model in batch. Thus, the step 1 forward propagation is performed. And the loss function is calculated according to the output of the decoder. Then the backward propagation is performed. As shown in FIG. 7, three MLs have a common CSI reconstruction part. The forward propagation and backward propagation make a loop.

Thus, each UE would contribute to the forward propagation. After the loss function is calculated, the back propagation begins and sends the updated parameters to each UE. At first all the UEs report the compressed CSI, and the ground truth. Then, after enough data is received in a batch, the loss value from the loss function is calculated. Then the gradient is calculated for the decoder. After that, the gradient is back propagated to each UE.

In some examples, the UEs report the forward propagation data and ground truth in a batch. Here is ground truth is the raw CSI (channel matrix after channel estimation, cither by ideal channel estimation, or non-ideal channel estimation). The batch size is configured to at least one UE by the BS in a broadcastlike-signalling. In some examples, the UEs report the forward propagation data and ground truth from a single measurement, or from a single input of the encoder. In some examples, the UEs report the forward propagation data and ground truth from a plurality of measurements, or from a plurality of inputs of the encoder. The report data and/or the specific number of inputs is configured by gNB, which can be a RRC signaling, MAC-CE or a DCI field. Back propagation is performed per batch for the involved UEs.

### Embodiment 4

FIG. 8 is a schematic diagram illustrating an example of forward propagation and backward propagation to train ML models having a common part according to an embodiment of the present disclosure. FIG. 8 illustrates that, in some examples, the UEs report the forward propagation in a batch, and the back propagation is performed to all the UEs, even though the UE does not report any forward propagation data since last propagation. One or more reports of forward propagation from one UE will trigger one back propagation of all the involved UEs. For the ML models with a common CSI reconstruction part, the involved UE does not expect receiving any backpropagation data for gradient descend during joint model training, if it has not sent any forward propagation data in one training loop. For the ML models with a common CSI reconstruction part, the involved UE does not expect receiving any data for gradient descend, during joint model training, if it has not sent any forward propagation data in one training loop.

### Embodiment 5

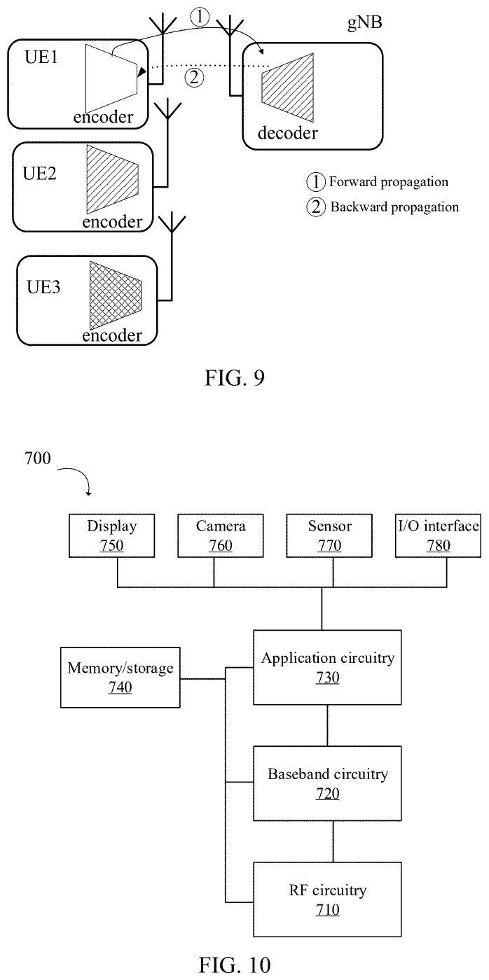

FIG. 9 is a schematic diagram illustrating an example of forward propagation and backward propagation to train ML models having a common part according to an embodiment of the present disclosure. FIG. 9 illustrates that, in some examples, the UEs report the forward propagation in a batch, and the back propagation is performed to the reporting UEs. The other UE who does not report the any does not report any forward propagation data since last propagation, will not perform back propagation. In another view, the training of the ML model part which is at the UE side, is performed individually and independent from the other UEs. The UE1, UE2 and UE3 are trained in turn. In some examples, the training method in embodiment 3, embodiment 4 and embodiment 5 are named as training type a, training type b and training type c. The gNB will configure specific training type to the UEs with a common ML model part. The configuration is provided to UE with RRC signaling/a MAC-CE or a DCI field.

In summary, in some embodiments of this disclosure, a method is provided for the training of a plurality of ML models with a common part. The common part can be either the CSI generation part or the CSI reconstruction part. A Broadcast-like signaling, e.g., a group common signaling (DCI 2_x) or a field in SIB/MIB is design for the training of a plurality of ML model for CSI feedback. This enables the training of a plurality of ML models with less signaling overhead. Besides, the solutions for how to update a CSI generation part based on the update of a CSI construction part are provided. Such that, the plurality of ML models with a common part can be trained properly. Some embodiments of this disclosure have at least one of the following invention effects: The overhead of training a plurality of ML models with a common part is reduced. The training of a plurality of ML models with a common part ML models should have some constraints. The update of a ML model part does not necessarily lead to the update of another model part.

FIG. 10 is a block diagram of an example system 700 for wireless communication according to an embodiment of the present disclosure. Embodiments described herein may be implemented into the system using any suitably configured hardware and/or software. FIG. 10 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The training is not limited to the report from a UE to a gNB. The training can be performed with a third node involved. The third node can be a UE, a gNB, or a server. If the third node is another gNB, all the signalings and data will be delivered to it for model training. The methods in the embodiments of this disclosure apply. After the model is trained, the ML model (common part) with be delivered to the second node (gNB). In this way, the signaling overhead is reduced between the sending node and the receiving node. In some examples, the gNB or the UE may be the sending node, and the third node may be the receiving node.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A method for configuring at least one first node training machine learning (ML) model, comprising:
being provided with a training assistant information by a second node, wherein the training assistant information is used for the first node to perform joint training with the second node to train a plurality of ML models having a common part.

2. The method according to claim 1, wherein the first node is a user equipment (UE), the second node is a base station, at least one third node is at least one another UE, an encoder of the UE and an encoder (CSI generation part) of the at least one another UE share a common decoder at the base station, the encoder of the UE and the encoder of the at least one another UE refer to one of a channel state information (CSI) generation part and a CSI reconstruction part, and the common decoder of the base station refers to the other of the CSI generation part and the CSI reconstruction part.

3. The method according to claim 1, wherein the training assistant information is contained in a UE-group common signaling or a broadcast signaling, which is contained in a downlink control information (DCI) 2_0 or a DCI 2_x, or the training assistant information is contained in a system information block (SIB) and/or a master information block (MIB).

4. The method according to claim 1, wherein the training assistant information comprises at least one of the followings: an activation/enabling of ML model training, a period of report forward propagation data, a period of report backward propagation data, a deactivation/disabling of ML model training, quantization information and an identification information.

5. The method according to claim 4, wherein the activation/enabling of ML model training and the deactivation/disabling of ML model training are DCI fields in the DCI 2_0 or a DCI 2_x.

6. The method according to claim 4, wherein the period of report forward propagation data and/or the period of report backward propagation data is configured by the second node and has bits, a list, or a table, or the period of report forward propagation data and/or the period of report backward propagation data is a default period.

7. The method according to claim 4, wherein the identification information comprises at least one of the followings: a cell identifier (ID) of a second node or a radio network temporary identifier (RNTI), where the UE-group common signaling is scrambled by a slot format indication radio network temporary identifier (SFI-RNTI) for the DCI_2.0 or a new RNTI for the DCI 2_x.

8. The method according to claim 1, wherein the at least one first node and the second node deployed with the ML models having a common part, where the at least one first node makes a group.

9. (canceled)

10. The method according to claim 1, wherein during training, a forward propagation and a backward propagation make a loop for encoders of the at least one first node the common decoder of the second node.

11. The method according to claim 10, wherein each of the at least one first node contributes to the forward propagation, after a loss function is calculated by the second node, the back propagation begins and send updated parameters to each of the first node and the at least one third node.

12. The method according to claim 10, wherein the at least one first node reports a forward propagation data and a ground truth in a batch, from a single measurement, from a single input of the encoder, from a plurality of measurements, or from a plurality of inputs of the encoder.

13. The method according to claim 1, wherein during training, the at least first node reports a forward propagation in a batch, and a back propagation is performed to all the at least one first node, even though some of the at least first node does not report the forward propagation since a last propagation.

14. The method according to claim 13, wherein one or more reports of the forward propagation from one of the at least one first node triggers one back propagation of all involved ones of the at least one first node.

15. The method according to claim 13, wherein for the ML models with a common CSI reconstruction part, involved one of the at least one first node does not expect receiving any data or any back propagation data for gradient descend during joint model training if a forward propagation data is not sent in one training loop.

16. The method according to claim 1, wherein the at least one first node reports a forward propagation in a batch, and a back propagation is performed to the reporting ones of the first node and the at least one third node.

17. The method according to claim 16, wherein the one of the at least one first node does not report any forward propagation data since a last propagation, does not perform the back propagation.

18. The method according to claim 16, wherein a training of a ML model part which is at the at least one first node, is performed individually and independent from the other of the at least one first node and the at least one first node performs training in turn.

19. The method according to claim 1, wherein a training type of ML models with a common part is configured by the second node.

20. (canceled)

21. A communication system, comprising:
a memory;
a transceiver; and
a processor coupled to the memory and the transceiver;
wherein the processor is configured to execute a method for configuring at least one first node training machine learning (ML) model, comprising:
being provided with a training assistant information by a second node, wherein the training assistant information is used for the first node to perform joint training with the second node to train a plurality of ML models having a common part.

22. A communication system for configuring at least one first node training machine learning (ML) model, comprising:
a first node and a second node, wherein the first node is provided with a training assistant information by the second node, wherein the training assistant information is used for the first node to perform joint training with the second node to train a plurality of ML models having a common part.
